(19) United States
(12) Patent Application Publication
(10) Pub. No.: US 2006/0041324 A1
(43) Pub. Date: Feb. 23, 2006

(54) System and method of editing a program used for a programmable logic controller

(76) Inventors: Yung-Liang Chang, Taoyuan (TW); Hsun-Ho Wang, Taoyuan (TW)

Correspondence Address: RABIN & BERDO, P.C., Suite 500, 1101 14 Street, N. W., Washington, DC, 20005, US

(21) Appl. No.: 10/968,136

(22) Filed: Oct. 20, 2004

(30) Foreign Application Priority Data
Aug. 20, 2004 (TW) 93125287

(51) Int. Cl. G05B 11/01; G06F 9/44

(52) U.S. Cl. 700/18; 717/163

(57) ABSTRACT

Disclosed is a system and method of editing a program used for a programmable logic controller (PLC), in which a menu-based operating interface is provided through which the user of the system may edit the program by selecting a predetermined number of instructions from a plurality of instructions provided in the menu and setting parameters corresponding to the selected instructions with an aid of an exclusive XOR operation on each of the selected instructions provided by the system, to avoid an erroneous logic sequence of the selected instructions occurring in the program so that the purposes of easy learning and correctness and reliability of the editing process may be achieved.

### BACKGROUND OF THE INVENTION

1. Field of Invention

The present invention relates to a system and method of editing a program used for a programmable logic controller (PLC), and particularly to a system and method of editing a program used for a PLC through a menu-based operating interface.

2. Related Art

With the progress of automated industry times, there has been a trend of using a programmable logic controller in controlling some outputting devices, such as a relay and an indicator light, in which a user thereof edits instructions and sets parameters associated therewith and the PLC generates controlling logics to control these outputting devices according to the instructions and the parameters associated therewith.

To constitute an instruction set used for a particular application, e.g. a high-speed counting, in a PLC, initializations of outputs, inputs and system parameters and even interruptions in the PLC are generally required to be set. In doing this, a programmer needs to edit the instruction set with the presence of a corresponding user manual and erroneous and missed logic sequences are generally occurring in the program unless a sophisticated programmer is involved and an outputting device controlled by the PLC may not be properly controlled.

Therefore, there is a need of providing an easy to be learned environment of editing a program used for a PLC, with reduced occurrence of erroneous program editing and improved correctness and reliability of the program thus edited.

### SUMMARY OF THE INVENTION

It is, therefore, an object of the present invention to provide a system and method of editing a program used for a programmable logic controller (PLC) in which a menu-based operating interface is provided through which a user of the system may edit the program by selecting a predetermined number of instructions from a plurality of instructions provided on the menu and setting parameters corresponding to the selected instructions with an aid of an exclusive XOR operation provided by the system on each of the selected instructions to avoid an erroneous logic sequence occurring in the program so that the purposes of easy learning and correctness and reliability of the program editing may be achieved.

To achieve the aforementioned object, the system of editing a program used for a PLC comprises a menu-based operating interface displaying module displaying a menu-based operating interface presenting a plurality of instructions arranged in a predetermined sequencing order so that a user of the system may select a first number of instructions therefrom in editing the program, a program instruction library connected with the menu-based operating interface displaying module, storing a plurality of program instructions and reading a first program instructions according and corresponding to the first number of instructions selected on the menu by the user, a logic determining module determining a second number of program instructions not in XOR relationship with each of the first numbers of program instructions corresponding to the selected first number of instructions, an instruction deleting module deleting a group of instructions selected by the user so that the user may re-select the first number of instructions in editing the program and a ladder diagram generating module, generating a ladder diagram according to the first number of program instructions after the program editing is finished.

To achieve the aforementioned object, the present invention also provides a method of editing a program used for a PLC, comprising the steps of selecting an instruction among a plurality of instructions, reading a program instruction corresponding to the selected instruction, determining a second number of program instructions not in XOR relationship with the program instruction corresponding to the selected instruction, displaying the second number of instructions not in XOR relationship with the program instruction corresponding to the selected instruction in a next selecting operation and repeating the above steps until the program editing is finished.

The method further comprises the steps of determining if a group of instructions selected by the user are to be deleted and determining if the program editing has been finished. If the program editing has been finished, the method further comprises the steps of displaying a first number of program instructions corresponding to a first number of selected instructions after the program editing is finished and a ladder diagram according to the first number of program instructions. When the first number of program instructions is transferred into the PLC, the PLC may control a device in a predetermined manner corresponding to the program edited as above.

With the system and method according to the present invention, the user thereof may edit a program used for a PLC through the simple menu-based operating interface. Further, the XOR operation between a program instruction corresponding to a current instruction and the plurality of program instructions stored in the program instruction library and thus a second number of program instructions obtained from the XOR operation may avoid erroneous logic sequence in the edited program so that the purposes of easy learning and correctness and reliability of the program may be promoted.

The principle of the present invention will be further explained through the description of preferred embodiments in the following and the claim of the present invention will also be defined as follows.

### BRIEF DESCRIPTION OF THE DRAWINGS

The invention will become more fully understood from the detailed description given hereinbelow illustration only and thus doesn't limit the present invention, wherein:

FIG. 1 is a block diagram of a system of editing a program used for a PLC according to the present invention;

FIG. 2 a flowchart of a method of editing a program used for a PLC according to the present invention;

FIG. 3 is a schematic illustration of an operating interface according to the present invention;

FIG. 4 is a schematic illustration of another operating interface according to the present invention;

FIG. 5 is a schematic illustration of yet another operating interface according to the present invention;

FIG. 6 is a schematic illustration of still another operating interface according to the present invention;

FIG. 7 is a schematic illustration of a ladder diagram corresponding thereto; and

FIG. 8 is a schematic illustration of a program instructions corresponding thereto.

### DETAILED DESCRIPTION OF THE INVENTION

The features and implementations will be described by way of preferred embodiments with reference to the accompanying drawings.

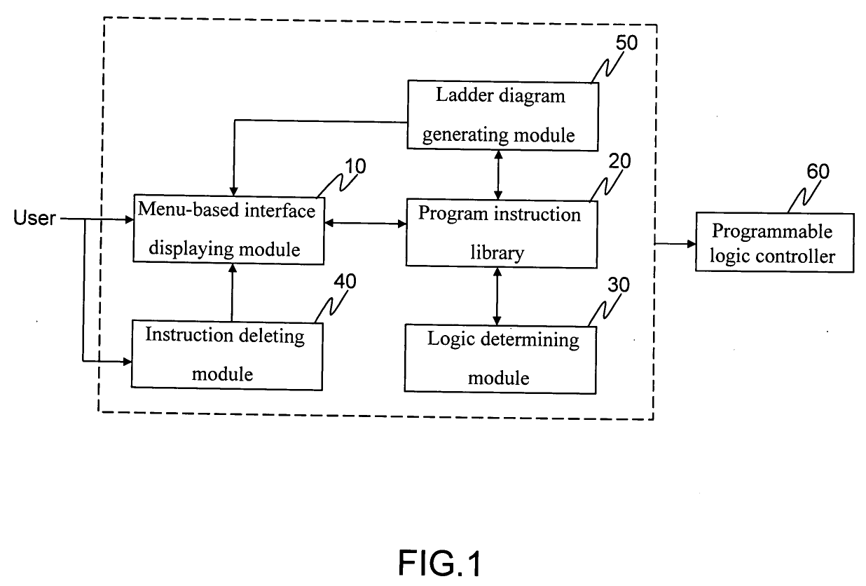

FIG. 1 is a block diagram of a system of editing a program used for a programmable logic controller (PLC). As shown, the system comprises a menu-based interface displaying module 10, a program instruction library 20, a logic determining module 30, a program instruction deleting module 40 and a ladder diagram generating module 50.

The menu-based interface displaying module 10 is used to display a plurality of instructions on the menu, wherein the plurality of instructions are arranged in a predetermined sequencing order through which a user of the system may select desired instructions in a simple and preferable manner. After the user has selected all the instructions he desires in editing the program (herein below, the selected instructions in a program is referred to as a first number of instructions), the menu-based displaying module 10 displays a first number of program instructions corresponding to the first number of instructions and a ladder diagram according to the first number of program instructions.

The program instruction library 20 is connected with the menu-based interface displaying module 10 and stores a plurality of program instructions corresponding to the plurality of instructions provided on the menu. According to instructions selected by the user, the program instruction library 20 reads program instructions corresponding thereto, in which the instructions provided on the menu are in a one-to-one relationship with the program instructions stored in the program instruction library 20. The program instructions may be roughly classified as a basic instruction group and an application instruction group. The basic instruction group comprises general instructions, output instructions, loop controlling instructions, high-speed processing instructions, arithmetic instructions, comparing instructions and so on.

The logic determining module 30 is connected with the program instructions library 20 and determines a plurality of program instructions not in XOR relationship with a current instruction among the plurality of instructions provided on the menu (herein below, such program instructions are referred to as a second number of program instructions) to avoid an erroneous logic sequence of program instructions occurring in the edited program.

The instruction deleting module 40 is connected to the menu-based interface displaying module 10 and used to delete a group of selected instructions. Since the selected instructions are all deleted, the user may re-select instructions from the state before editing the program.

The ladder diagram generating module 50 is connected with the menu-based interface displaying module 10 and the program instruction library 20. The ladder diagram generating module 50 generates a ladder diagram according to the first number of program instructions corresponding to the selected first number of instructions and the ladder diagram is displayed through the menu-based interface displaying module 10 so that the user may debug the edited program there through.

After the program editing is finished and transferred into a PLC 60, an outputting device designed to be controlled by the program may be controlled by the PLC 60 in a specific manner corresponding to the program.

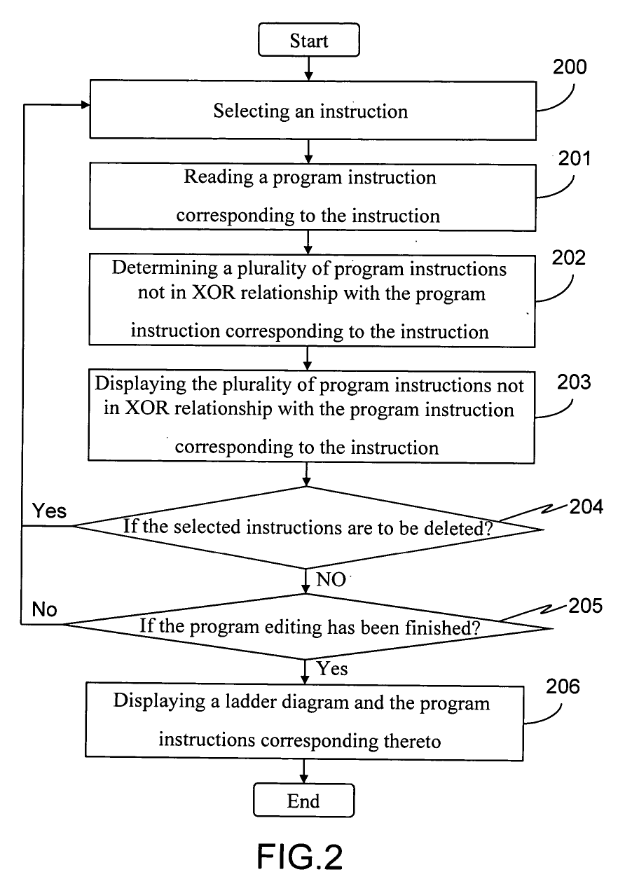

Referring to FIG. 2, a flowchart of a method of editing a program used for a PLC according to the present invention is illustrated therein. First, selecting an instruction from a plurality of instructions on a menu (200). Then, reading a program instruction corresponding to the instruction selected on the menu from a program instruction library by an editing system (201), wherein the first number of instructions provided on the menu are in a one-to-one relationship with a first number of program instructions stored in the program instruction library. Next, determining a first number of program instructions not in XOR relationship with the selected instruction (202). Namely, the editing system determines a relationship between each of the first program instructions corresponding to the selected first number of instructions and the other program instructions stored in the program instructions library. If one of the first number of program instructions is determined as having an XOR relation with a third number of program instructions in the program instruction library, then the user may not select instructions on the menu corresponding to the third number of program instructions in a next selecting operation. Namely, only a second number, equal to the first number minus the third number) of program instructions may be selected in the next selecting operation. Next, displaying the second number of instructions on the menu that are allowed to be selected in the next selecting operation (203), to avoid an erroneous logic sequence of program instructions occurring in the edited program.

Next, determining if the currently selected instructions have been deleted (204). If the user desires to re-edit the program and thus re-selects instructions provided on the menu, he may first delete all the currently selected instructions and then go back to Step 200 to launch a program re-editing operation.

Thereafter, determining if the program editing has been finished (205). That is, if all the parameters for each instruction are displayed, the editing system determines if a “Finished” icon is clicked by the user. If it is determined the program has not been finished, the editing process goes back to Step 200 and the user continues to set parameters associated with the required instructions.

If the program editing is determined finished, the editing system displays all the first numbers of program instructions corresponding to the selected first number of instructions and a ladder diagram according to the first number of program instructions (206). Through the relationship between the ladder diagram and the first number of program instructions, the user determines if the program corresponding to the controlling operation of the PLC on a controlled outputting device designed to be controlled by the program is correct. If the program is correct with respect to the controlling operation on the controlled outputting device, the user may transfer the program into the PLC to control the controlled device.

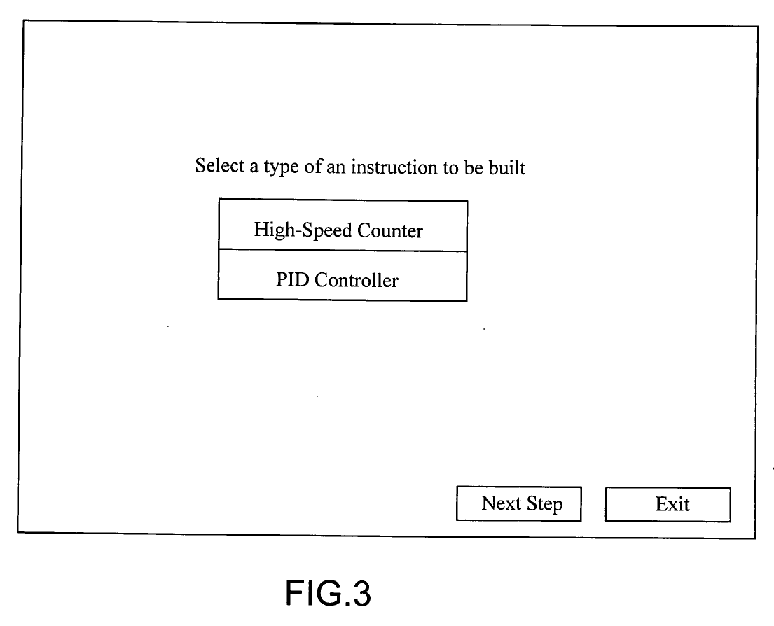

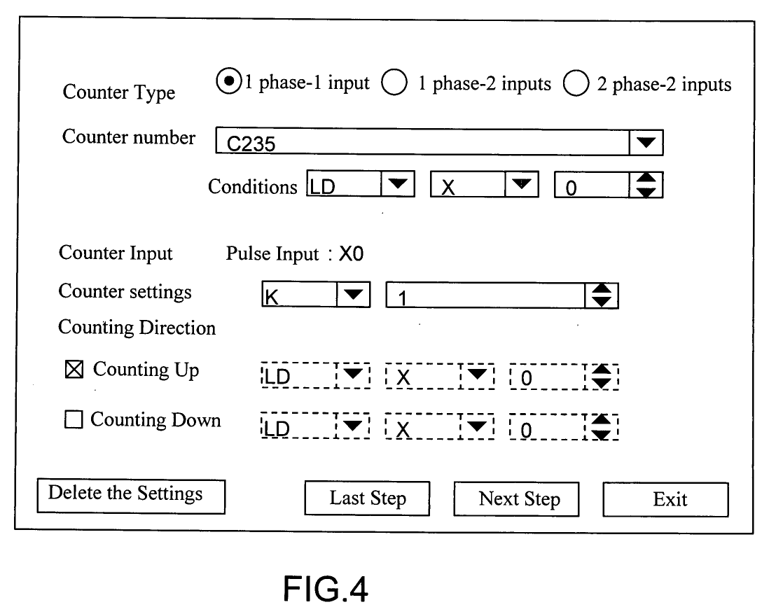

Referring to FIG. 3, an operating interface of editing a program used for a PLC according to the present invention is schematically illustrated therein. First, the user selects a type of an instruction he desires to select, in this case the type of high-speed counter or PIC controller. Now, it is assumed the “High Speed Counter” icon is clicked and then the icon “Next Step” is clicked. Next, parameters associated with the instruction type “High-Speed Counter” may be set. Referring to FIG. 4, the parameters needed to be set include the counting type, the counter number, the input of the counter, the counter settings and the counting direction. To avoid missed parameter settings and erroneous logic sequence of program instructions, these parameters are to be inputted in a sequencing manner corresponding to a specific logic sequence.

In the description above, the counter type may be selected with only a single type among a “1 phase-1 input”, a “1 phase-2 inputs” and a “2 phases-2 inputs”-type. Then, the counter number, the counting condition, the input of the counter, the counter settings are also required to be set in the sequencing order.

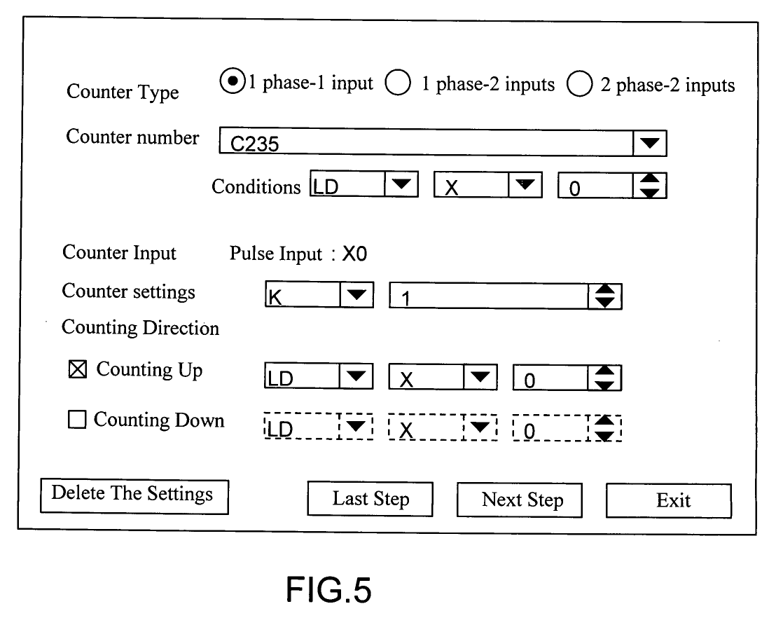

Referring to FIG. 5, “Counting Up” and Counting Down” are to be selected for the “Counting Direction” and only one of them, i.e., the region limited by the dotted lines in FIG. 4, are selected with the parameters in an underlay to the frame corresponding to the dotted lines be set. In this manner, the program instructions corresponding to the selected instructions may be avoided from an erroneous logic sequence thereof.

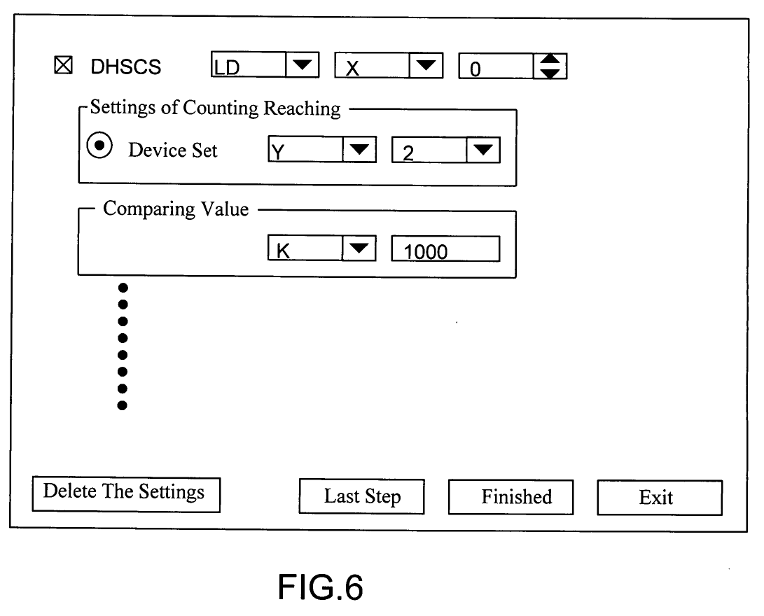

In addition, when the user desires to re-select instructions, he may click the icon “Delete the Settings” so that the state on the menu may get back to the state before any instruction is selected. Next, the user may click the icon “Next Step” to continue a re-selecting operation. Referring to FIG. 6, another operating interface of editing a program used for a PLC according to the present invention is illustrated therein. As shown, parameters corresponding to some instructions among the first number of instructions are respectively to be set by the user. When the user selects the instruction “DHSCS”, he may enter the “Settings of Counting Reaching” to set parameters associated with a “Device Connecting Point” and a “Comparing Value”. Through the menu-based operating interface, the parameters required to be set are listed one by one so that the user may not miss any parameter and the correctness and reliability of editing the program for a PLC may be promoted.

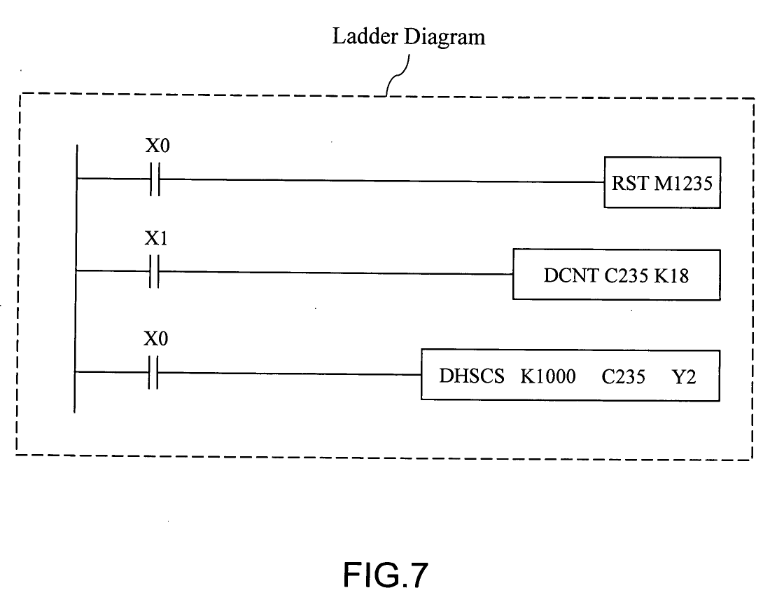

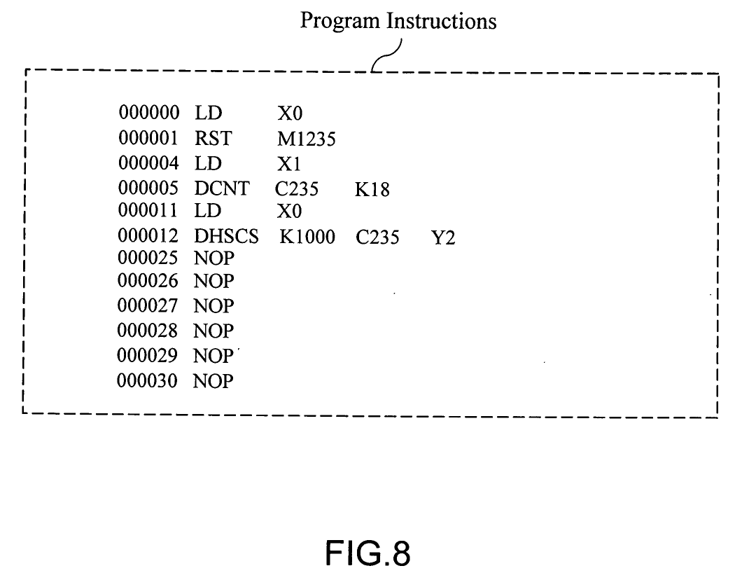

Referring to FIG. 7 and FIG. 8, the ladder diagram and the first number of program instructions corresponding to the first instructions selected in the program are illustrated therein. When the user finishes with the program editing and then clicks the icon “Finished”, the editing system displays the ladder diagram and the corresponding first number of program instructions. Through the ladder diagram, the user may check if nodes and the parameters are correctly set. If the modes and the parameters are set correctly, the user may transfer the first number of program instructions into a PLC and control the corresponding outputting device by executing the program in the PLC.

With the system and method of editing a program used for a PLC according to the present invention, the user thereof may edit a program used for a PLC through the simple menu-based operating interface. Further, the XOR operation for each of the first numbers of program instructions may avoid an erroneous logic sequence of program instructions in the edited program so that the purposes of easy learning and correctness and reliability of the program may be promoted.

While the preferred embodiments of the present invention have been set forth for the purpose of disclosure, modifications of the disclosed embodiments of the present invention as well as other embodiments thereof may occur to those skilled in the art. Accordingly, the appended claims are intended to cover all embodiments, which do not depart from the spirit and scope of the present invention.

1. A system of editing a program used for a programmable logic controller (PLC), comprising:
a menu-based operating interface displaying module displaying a menu-based operating interface presenting a plurality of instructions arranged in a predetermined sequencing order so that a user of the system may select a first number of instructions therefrom;
a program instruction library connected with the menu-based operating interface displaying module, storing a plurality of program instructions corresponding to the plurality of instructions and reading the first number of program instructions; and
a logic determining module determining a second number of program instructions not in XOR relationship with each of the plurality of program instructions corresponding to one of the selected first number of instructions so that the user may only select the second number of program instructions not in XOR relationship with each of the plurality program instructions.

2. The system as recited in claim 1, further comprising an instruction deleting module deleting a group of instructions selected by the user so that the user may re-select the first number of instructions in editing the program.

3. The system as recited in claim 1, further comprising a ladder diagram generating module generating a ladder diagram according to the first number of program instructions after the program editing is finished.

4. The system as recited in claim 3, wherein the operating interface displaying module further displays the ladder diagram after the program editing is finished.

5. The system as recited in claim 4, wherein the operating interface displaying module further displays the first number of program instructions.

6. A method of editing a program used for a PLC, comprising the steps of:
(a) selecting an instruction from a plurality of instructions by a user;
(b) reading a program instruction corresponding to the selected instruction;
(c) determining a second number of program instructions among a plurality of program instructions corresponding to the plurality of instructions not in XOR relationship with the program instruction corresponding to the selected instruction;
(d) displaying the second number of program instructions not in XOR relationship with the program instruction corresponding to the selected instruction; and
(e) repeating the steps of (a), (b), (c) and (d) until the program editing is finished and a first number of instructions are selected in the finished program.

7. The method as recited in claim 6, wherein the plurality of instructions are arranged in a specific sequencing order.

8. The method as recited in claim 6, further comprising a step (d′) of determining if a set of currently selected instructions are to be deleted so that the user may re-select the first number of instructions from the plurality of instructions after the step (d).

9. The method as recited in claim 6, further comprising a step (d″) of determining if the program editing has been finished after the step (d).

10. The method as recited in claim 9, further comprising a step (e′), after the step (e), of displaying a ladder diagram corresponding to the first number of program instructions after the program editing is finished.

11. The method as recited in claim 9, further comprising a step (e″), after the step (e′), of displaying the first number of program instructions after the program editing is finished.
